(19) United States
(12) Patent Application Publication
(10) Pub. No.: US 2011/0025221 A1
(43) Pub. Date: Feb. 3, 2011

(54) ULTRAVIOLET GENERATING DEVICE AND LIGHTING DEVICE USING THE SAME

(75) Inventors: Kazunori Matsumoto, Toyama (JP); Yuki Taira, Toyama (JP)

Correspondence Address: HAMRE, SCHUMANN, MUELLER & LARSON, P.C., P.O. BOX 2902, MINNEAPOLIS, MN, 55402-0902, US

(73) Assignee: TOYAMA PREFECTURE, Toyama (JP)

(21) Appl. No.: 12/936,053

(22) PCT Filed: Apr. 1, 2009
(86) PCT No.: PCT/JP2009/056800

§ 371 Date: Oct. 1, 2010

(30) Foreign Application Priority Data
Apr. 2, 2008 (JP) 2008-096554
Aug. 27, 2008 (JP) 2008-217557

(51) Int. Cl. H05B 41/16; H01J 61/12; H01J 1/62

(52) U.S. Cl. 315/248; 313/637; 313/484

(57) ABSTRACT

Device generating high-luminance and highly-efficient ultraviolet rays by applying polyphase alternating current discharge plasma in a multi-poled magnetic field to a light source for generating ultraviolet rays and using a usual molecular gas other than mercury and rare gases. The inside of a flat container 3 is evacuated, and 1 Torr or less of a molecular gas for use in discharge light emission fills therein or is flowed thereinto. Next, a phase-controlled twelve-output alternating current power supply of 1 kW or lower is connected to twelve divisional electrodes 1 for supply of discharge electric energy. Thus, plasma P occurs with stable alternating-current glow discharge along the surface of the divisional electrodes 1 covered with a barrier layer 2. As a result of discharge, light with a wavelength unique to the molecular gas that contains ultraviolet rays is emitted and extracted outside from a light extraction window 32.

### TECHNICAL FIELD

The present invention relates to a mercury-less ultraviolet generating device, which utilizes a novel electric discharge technology of efficiently and stably generating a high-density weakly-ionized low-temperature plasma, and also relates to a lighting device, which applies the generated ultraviolet rays to a lighting.

### BACKGROUND

Ultraviolet and vacuum ultraviolet rays obtained from a discharge gas of hydrogen, xenon, or krypton are widely used in various fields such as photochemical engineering, semiconductor manufacturing process, food and medical sterilization, and lighting devices when the rays are converted into visible light by exciting fluorescent material. However, mercury is a harmful substance to global environment and is refrained from being used, while xenon and krypton gases are rare materials, and their use is limited. Therefore, it is necessary to develop an ultraviolet and vacuum ultraviolet generating device and a lighting device using a usual molecular gas, other than mercury and rare gasses, as a discharge gas.

Generally, in low-pressure glow discharge using monatomic mercury and xenon gases, the each emitted light spectrum is discontinuous and has a line spectrum with a wavelength unique to a discharge gas. This is because, when atoms excited with electrons are relaxed, a transition between in specific energy state levels occurs, and according to this, lights are emitted.

On the other hand, in low-pressure glow discharge using a molecular gas formed of two or more atoms, each emitted light spectrum is continuous. This is because vibrational and rotational excitation states are added to an electronic excitation energy state to make a transition between energy levels continuous. Therefore, to efficiently obtain ultraviolet radiation from a molecular gas, it is required to select a gas with an appropriate energy transition state from various molecular gases.

Also, in glow discharge plasma, to effectively excite the molecular gas with a sufficient strength, a high-output, highly-efficient plasma generating device is required.

The Applicant previously filed an application, Japanese Unexamined Patent Application Publication No. 8-330079, in which a phase controlled multi-output-type alternating-current power supply device constituted of a plurality of alternating-current outputs with the phases arranged (controlled/adjusted) is disclosed as a low-frequency alternating-current power supply capable of stably generating a large amount of discharge (weakly-ionized low-temperature plasma) at low cost. By using the aforesaid power supply, the applicant further discloses an electrode assembly to efficiently generate electric discharge in Japanese Patent No. 3772192, and a method of configuring a magnetic field in Japanese Patent No. 3742866. The method of constituting said electrode assembly is to closely attach and fix a plurality of electrode pieces to a cooled inner wall of the device via an thermally conductive insulating sheet, and the method of constituting a magnetic field is to establish a magnetic field in the vicinity of each electrode surface to suppress outflow of plasma by attaching a plurality of magnets onto the outer wall of the device.

The Applicant further discloses a high-output, highly-efficient discharge-type lighting device with a high energy-saving effect by using the wall-fixed electrode pieces to efficiently generate electric discharge with a phase-controlled polyphase alternating-current power supply and the multi-poled magnetic field in Japanese Patent No. 3472229.

### Patent Document 1: Japanese Unexamined Patent Application Publication No. 8-330079

### Patent Document 2: Japanese Patent No. 3772192

### Patent Document 3: Japanese Patent No. 3742866

### Patent Document 4: Japanese Patent No. 3472229

### SUMMARY OF THE INVENTION

It is an object of the present invention to apply polyphase alternating-current discharge plasma in a multi-poled magnetic field to an ultraviolet generating light source without using mercury, which is harmful to global environment, but using a molecular gas to generate high-luminance, highly-efficient ultraviolet rays.

To attain this object, the primary feature of the present invention is generating a plurality of ultraviolet rays by exciting a discharge gas with a weakly-ionized low-temperature plasma, wherein the discharge gas is a mixed gas of a nitric oxide and a diluent gas.

Related documents are as follows:

### 1) Japanese Unexamined Patent Application Publication No. 56-6364, “Low-Pressure Hollow Cathode Lamp Having Nitrogen/Oxygen Enclosure”, Michael Zoechbauer (Federal Republic of Germany) et al.

### 2) Japanese Unexamined Patent Application Publication No. 2002-304970, Phase-Controlled Multi-Electrode-Type Alternating-Current Discharge Light Source, Kazunori Matsumoto

### 3) The 5^{th} National Meeting of the Japan Society of Applied Physics, Lecture Draft Copies p. 247, 2008/3

4) Research Reports of the Postgraduate Electronic Science and Technology Research course, Shizuoka University (29)

Note that, although no reference is made to in these related documents, it has been conventionally known that nitric oxide gas NO has an absorption spectrum or an emission spectrum (molecular potential curve) called a γ spectrum in an ultraviolet region from 150 nm to 230 nm.

Related Document 1) describes the case in which ultraviolet rays are emitted with discharge by using only NO gas. Since the filling NO gas dissociates with discharge to change composition, a method of preventing this is suggested. Also, to prevent the depletion of the metal electrode pieces by reacting with oxygen dissociated from NO due to the exposed metal electrode pieces, the metal electrode pieces are coated with metal oxide before being inserted inside the discharge tube.

Related Document 4) describes a method of using discharge in a mixed gas of nitrogen N₂ and oxygen O₂ without using nitric oxide NO itself, that is, dissociating nitrogen molecules and oxygen molecules into nitrogen atoms N and oxygen atoms O respectively to synthesize nitric oxide NO.

On the other hand, Related Document 2) and Document 3) are an application and a presentation by the inventors and others regarding a power supply for use in the present invention, but nothing concerning the present invention is disclosed.

A feature of the present invention is that effective ultraviolet rays can be emitted from NO with an intensity at a practical level for the first time ever by mixing nitrogen with nitric oxide NO. Thus, the present invention is totally different from the above Related Documents 1) to 4).

In the present invention, since a mixed gas of nitric oxide and a diluent gas is used as a discharge gas, strong ultraviolet rays can be obtained even with low electric power. By applying these rays to a fluorescent material, a high-luminance, highly-efficient, mercury-less lighting device can be achieved.

### BRIEF DESCRIPTION OF DRAWINGS

FIG. 1 A section view of an ultraviolet generating device in which the present invention is implemented.

FIG. 2 A power-supply connection diagram of the ultraviolet generating device in which the present invention is implemented.

FIG. 3 A diagram depicting changes of emission spectrums with three types of molecular gas.

FIG. 4 A diagram depicting changes of ultraviolet intensities with concentration of nitric oxide with respect to nitrogen.

FIG. 5 A diagram depicting ultraviolet emission distributions with pressure with and without a magnetic field.

FIG. 6 A diagram depicting changes of emission spectrums with two types of molecular gas.

FIG. 7 A diagram depicting changes of ultraviolet intensities with concentration of carbon oxide with respect to hydrogen.

FIG. 8 Structure diagrams of multi-race and double-comb-type magnetic fields.

FIG. 9 Diagrams depicting emission distributions with pressure in the multi-race and double-comb-type magnetic fields.

FIG. 10 A potential-curve diagram of nitric oxide.

FIG. 11 Metastable levels of main atoms are depicted.

FIG. 12 Metastable levels of main molecules are depicted.

FIG. 13 Diagrams depicting changes of emission spectrums with two types of molecular gas, an upper diagram being in the case of a nitrogen-oxygen mixed gas simulating air depicted in Related Document 4) and a lower diagram being in the case of nitric oxide gas diluted with Ar.

### BEST MODE FOR CARRYING OUT THE INVENTION

In the following, an embodiment of the present invention is described.

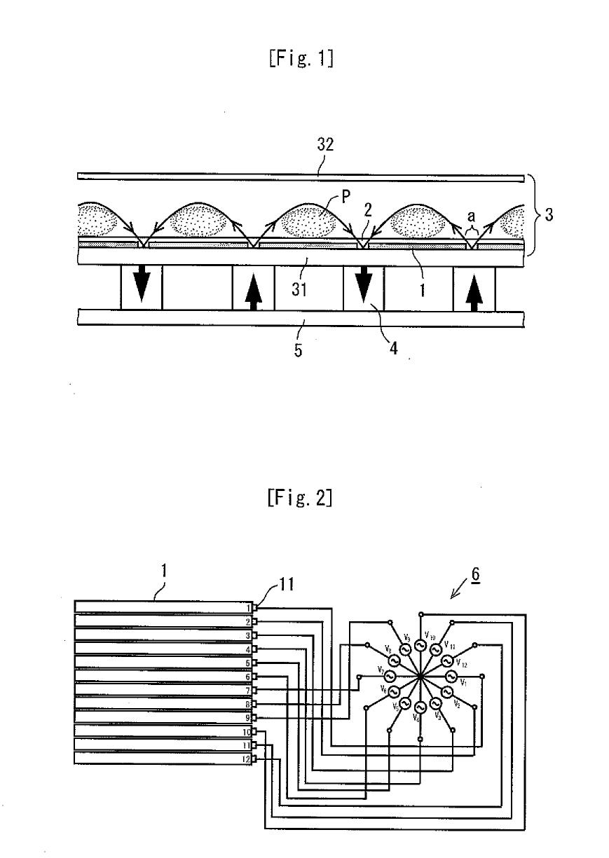

FIG. 1 depicts a section view of a lighting device in which the present invention is implemented.

In the lighting device, twelve sheet-shaped divisional electrodes 1 are buried into a barrier layer 2 with slight spaces a therebetween, and are closely attached and fixed with a substrate 31 on a bottom surface of a flat container 3.

An opposite surface facing the substrate 31 is covered with a light extraction window 32 with its inside coated with a fluorescent material b (not shown in FIG. 1) to shield the flat container 3 to form a low-pressure discharge chamber.

The divisional electrodes 1 are disposed so as to have as large area as possible to cover the entire substrate 31.

As the barrier layer 2, a material with an excellent electric insulation and thermal conductivity is used, for example, quartz glass or boron nitride, to form an insulator layer.

On the outside of the substrate 31, twelve+one rod magnets 4 arranged with adjacent polarities opposite to each other are closely attached and fixed each along the spaces a. The arrows depicted on the magnets 4 indicate directions of magnetic poles, and with these, a multi-poled magnetic field is formed so that the magnetic lines of force cover the surface of the divisional electrodes 1.

The outside of the substrate 31 having the magnets 4 mounted thereon is covered with a magnetic shield plate 5, thereby not diverging the magnetic lines of force to the outside but concentrating them onto the inside.

As the magnets 4 for a multi-poled magnetic field, electromagnetic coils may be used in place of permanent magnets.

Alternatively, sheet magnets 4, such as rubber magnets, may be interposed between the barrier layer 2 and the substrate 31 or be pasted on the outside of the substrate 31 to form a multi-poled magnetic field. Thus, the thickness of each of the magnets 4 is decreased, and accordingly the shape of the lighting device can be made thinner and compact.

Here, although the positional relation between the magnets 4 and the divisional electrodes 1 is arbitrary, FIG. 1 depicts the case in which each magnet 4 is placed straight behind the space a between one divisional electrode 1 and another divisional electrode 1. At this time, the multi-poled magnetic field is formed so as to cover the surface of the divisional electrodes 1 with magnetic lines of force, and therefore plasma P is effectively confined near the surface of the divisional electrodes 1. In this manner, when the plasma P is confined in a surficial thin layer, excitation of molecular gas is increased, and strong ultraviolet rays can be emitted from that thin layer.

To the twelve sheets of divisional electrodes 1, as depicted in FIG. 2, a twelve-phase alternating-current power supply 6 having phases shifted by a 1/12 cycle and having the same amplitude is connected via feeding terminals 11 each mounted at one end of each divisional electrode 1.

The twelve-phase alternating-current power supply 6 is configured by making a star connection of low-frequency alternating-current power supplies with their frequencies, amplitudes, and phases (including waveform) controlled. The entire power supply has a floating potential remained as it is by an isolation transformer, then discharge is caused only between the divisional electrodes 1.

As for the number of phases of the power supply, in the case of four phases or more, as the number of phases increases, a uniform region in a potential distribution, that is, a uniform region in an electric field, increases. However, in the case of twelve phases or more, the increasing tendency is saturated. Therefore, twelve phases are within a practical category.

The lighting device in which the present invention is implemented is configured as described above. The inside of the flat container 3 is vacuum evacuated with an exhaust device (not shown), and 1 Torr or less of a molecular gas for use in discharge light emission fills therein or is flowed thereinto.

This molecular gas is namely a discharge gas and, in the present invention, a mixed gas of nitric oxide and a diluent gas is used. As a diluent gas, a chemically stable gas having a metastable level slightly higher than an excitation level of nitric oxide of about 6 eV is used. Specifically, nitrogen gas is optimum. The reason is that the nitrogen gas has a metastable state at an energy level slightly higher than excitation energy of nitric oxide emitting ultraviolet rays of 300 nm or shorter.

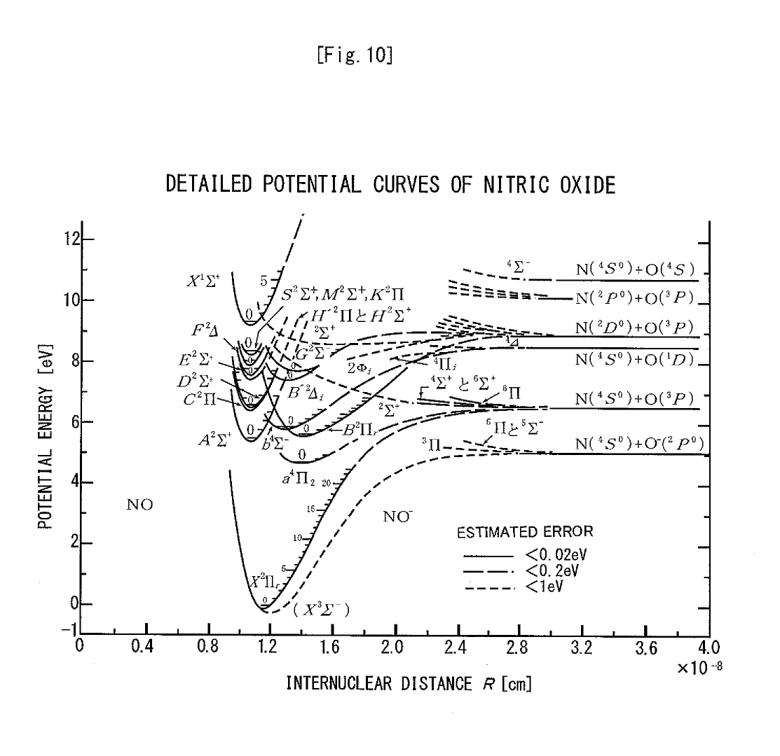

FIG. 10 depicts a potential-curve diagram of nitric oxide, in which the ultraviolet rays in the present invention are emitted when the electron state of nitric oxide transits from an energy level represented by a spectral term of A²Σ⁺ to a level represented by X²Πr. An energy difference therebetween is approximately 6 eV, and corresponds to energy of a photon having a wavelength of about 200 nm.

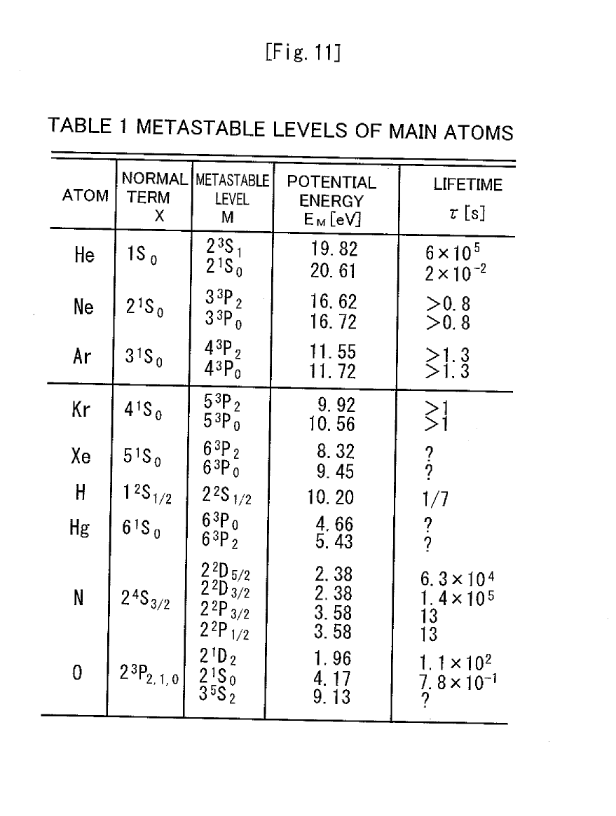

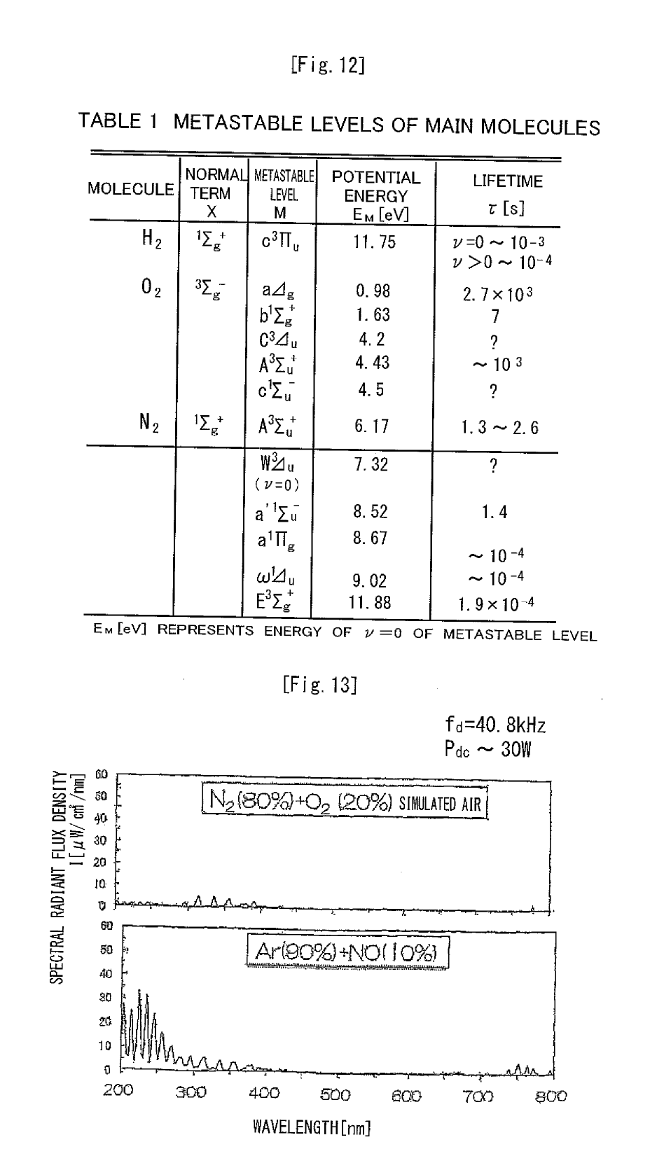

FIGS. 11 and 12 depict metastable levels of main molecules and atoms. In a nitrogen molecule N₂, a metastable level of A³Σᵤ is present, and its energy is 6.17 eV, and its lifetime is long with from 1.3 to 2.6 seconds, which can be found to be extremely long compared with a normal lifetime of about 10⁻¹² seconds. Also, the molecular mass of nitrogen molecule is 28, and the molecular mass of nitric oxide is 30. Because of the similarity in mass, when these two collide with each other, energy is efficiently exchanged. That is, when N₂ in a metastable state of A³Σᵤ with energy of 6.17 eV collides with NO in a ground state, NO is efficiently excited to the level of A²Σ⁺ having energy of 6 eV. When a transition is made from this level to a ground state, ultraviolet rays are emitted in the vicinity of about 200 nm.

When dilution is made with Ar gas having a similar metastable level in place of the nitrogen gas, as depicted in a lower diagram in FIG. 13, the ultraviolet radiation intensity is not much different from the case of pure NO. This is because the energy level of the metastable level of argon is high about 12 eV, and even when NO is excited to 6 eV, the remaining approximately 6 eV becomes wasted, and also because the atomic mass is 40, which is 1.3 times as large as that of NO of 30.

Other than nitrogen gas and Ar gas, xenon gas can be used. Xenon Xe has a metastable level at an energy level of 8.32 eV, which is slightly higher than the excitation level of about 6 eV of nitric oxide, and therefore an effect approximately equivalent to that of the nitrogen gas can be expected. However, Xe has an atomic mass of 131, and is much heavier than nitric oxide having a molecular mass of 30. Therefore, when they are compared with each other, the nitrogen molecular gas (with a molecular weight of 28) is lighter than the xenon gas, and thus can be suitable as a diluent gas.

Note that an upper diagram in FIG. 13 depicts data from the inventors and others when a nitrogen-oxygen mixed gas simulating air in the conventional art depicted in Related Document 4). As evident from this, it can be found that radiation from NO in case of simulating air is extremely small. The reason for this is that mixed oxygen easily changes nitric oxide NO to more stable nitrogen dioxide NO₂, thereby significantly decreasing the absolute magnitude of NO. That is, only when nitric oxide is slightly mixed with the nitrogen molecular gas, ultraviolet rays are emitted from NO with a practical intensity, which becomes obvious for the first time ever by the present invention.

The reason for nitrogen being effective as a diluent gas for nitric oxide is as follows. The nitrogen molecules, which form a main filling gas, are immediately recombined with oxygen dissociated from nitric oxide molecules due to discharge, and therefore changing the composition of the nitric oxide gas due to discharge is avoided and, as a result, stable, strong ultraviolet rays can be obtained.

As a molecular gas, various compounds have been studied and tested so far. In particular, compounds that become a gas state at room temperature or when slightly heated, such as carbon C, nitrogen N, oxygen O, sulfur S, selenium Se, and tellurium Te, have been tested. A major problem is that, in a discharge state, a compound is dissociated to form another solid compound in a device and the composition of the molecular gas is changed from an initial state, or a light extraction window is fogged.

And, the phase-controlled twelve-output alternating-current power supply of 1 kW or lower is connected to the twelve divisional electrodes 1 to supply discharge electrical energy.

With this, as depicted in FIG. 1, the plasma P occurs by alternating-current glow discharge along the surface of the divisional electrodes 1 covered with the barrier layer 2.

When twelve-phase alternating voltages are applied to the twelve divisional electrodes 1, discharge circulates once among the divisional electrodes 1 during one cycle, and therefore discharge rotates as many as applied frequencies during a second. Therefore, discharge occurs between any divisional electrodes 1 at any time, and continuous discharge occurs like high-frequency lighting, even with low-frequency alternating discharge. Plasma P occurring as a result of discharge is confined in a narrow, thin region by the multi-poled magnetic field, collision excitation with plasma of electrically-neutral molecular gas (neutral gas) becomes active, thereby increasing luminous density and luminous efficiency from the excited neutral gas.

As a result of such continuous discharge, light having a wavelength unique to the molecular gas containing ultraviolet rays are stably emitted in a spatially-uniform manner over the entire electrodes. These ultraviolet rays are converted into visible light by the fluorescent material b coating the inside of the light extraction window 32. Since the plasma region and the light-emitting layer are thin, light is not reabsorbed and has a high luminance.

The dimension and arrangement of the divisional electrodes are not restricted to those depicted in FIG. 1. Also, the number of phases of the alternating-current power supply is not restricted to twelve. The dimension and arrangement of the divisional electrodes and the number of phases and the magnitude of power of the alternating-current power supply are adjusted as appropriate so that ultraviolet radiation is optimum for a substance to be radiated.

The generated ultraviolet rays are applied to a fluorescent material for conversion into visible light for a lighting device, also can be used for sterilization of foods and pharmaceuticals avoiding degeneration by heating and, furthermore, can be applied to photochemical reaction.

### First Embodiment

In the following, an embodiment of the present invention (experimental result) is described.

An experiment was performed by connecting the inverter-type twelve-phase alternating-current power supply 6 of 30 W or lower and 40 kHz to the lighting device of the present invention and putting 0.17 to 0.3 Torr of the following three types of molecular gas into the vacuum evacuated device.

Discharge emission spectrums were measured by an optical-fiber-type multi-channel spectroscope.

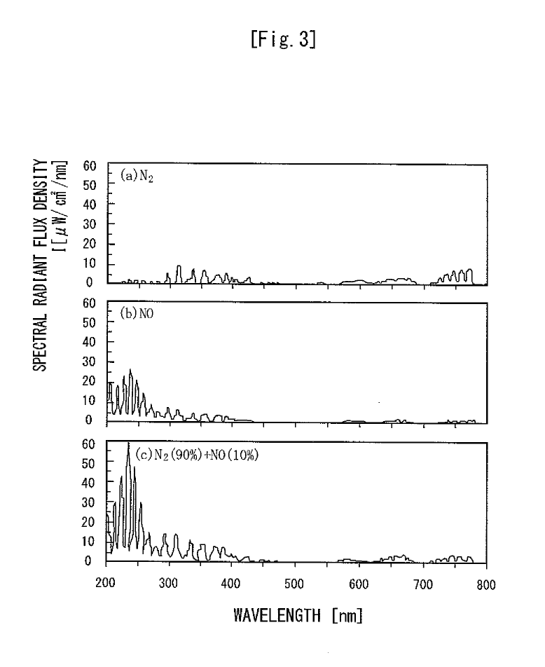

FIG. 3 depicts discharge emission spectrums in a multi-poled magnetic field with three types of molecular gas.

FIGS. 3(a), (b), and (c) depict spectrums when nitrogen, nitric oxide, and a nitrogen-diluted (90%) nitric oxide (10%) gas were used, respectively. Here, the vertical axis represents spectral radiant flux densities [μW/cm²/nm] calibrated with a standard light source.

In the case of the nitrogen gas in FIG. 3(a), as conventionally reported, ultraviolet radiation was observed from a wavelength region of from 300 nm to 380 nm.

In the case of the nitric oxide gas in FIGS. 3(b) and 3(c), this experiment was tried for the first time ever by the inventors, and ultraviolet radiation was observed from a wavelength region of from 200 nm to 380 nm.

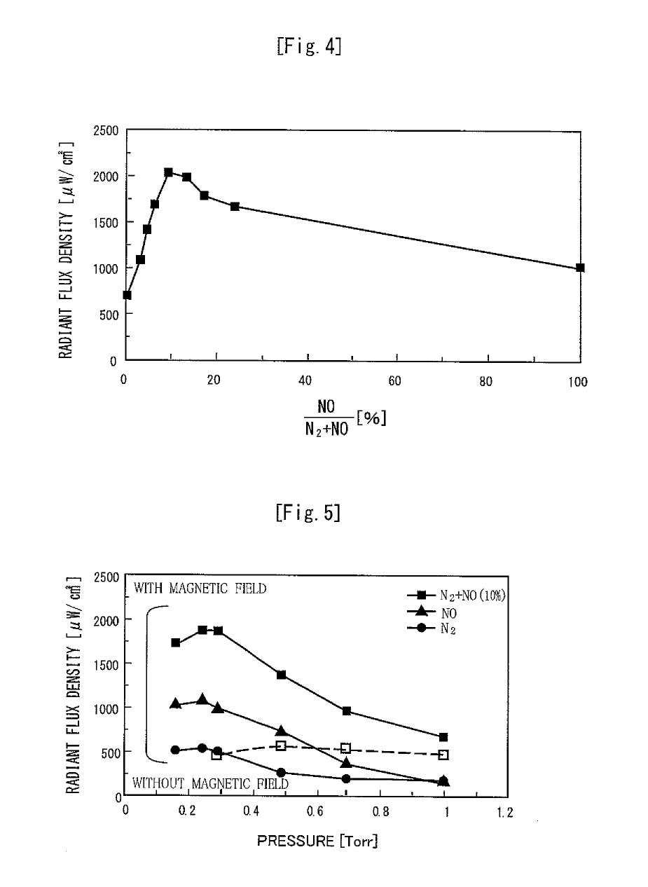

Furthermore, as depicted in FIG. 4, it was found that ultraviolet radiation is maximum from the said region when nitric oxide is diluted with nitrogen and the concentration of nitric oxide is approximately 10%.

Here, the vertical axis in FIG. 4 represents radiant flux densities [μW/cm²], and the horizontal axis represents a concentration of nitric oxide NO/N₂+NO [%].

From this FIG. 4, it can be found that the radiant flux density is large when the concentration of nitric oxide of the nitrogen-diluted nitric oxide gas is within a range of from 5 to 50%, and is small when it is outside of this range. The reason for this is considered as follows. If the concentration of nitric oxide is smaller than 5%, the number of nitric oxide molecules, which are main constituents of ultraviolet and vacuum ultraviolet emission, is insufficient. If the concentration exceeds 50%, it becomes difficult to effectively excite nitric oxide by nitrogen molecules, which is a diluent gas.

FIG. 5 depicts radiant flux densities, obtained by integrating spectral radiant flux densities over an ultraviolet region (from 200 nm to 380 nm, with respect to pressure in three types of molecular gas. Here, black circles represent radiant flux densities in the case of nitrogen molecules, data with black triangular marks represents that in the case of nitric oxide, and data with black square marks represents that in the case of nitrogen-diluted nitric oxide (10%). Also, data with white square marks connected by a broken line represents that in the case of nitrogen-diluted nitric oxide (10%) without a magnetic field.

Without a magnetic field, little change was observed even when the pressure decreased.

By contrast, in a multi-poled magnetic field, as the pressure decreased, the ultraviolet luminous intensity increased.

This is because, when the pressure decreases, plasma-neutral gas collisions decrease and the plasma confining effect by the magnetic field increases. Here, the multi-poled magnetic field in any of FIG. 3, FIG. 4, and FIG. 5 is a multi-race-type multi-poled magnetic field.

The magnitude of the ultraviolet radiation density with a pressure of the nitrogen-diluted nitric oxygen mixed gas of 0.3 Torr was 1.5 times as large as a value observed when mercury was used in the same device.

Although argon gas was tried as a diluent gas of nitric oxide, ultraviolet radiation was smaller than that in the case of dilution with nitrogen.

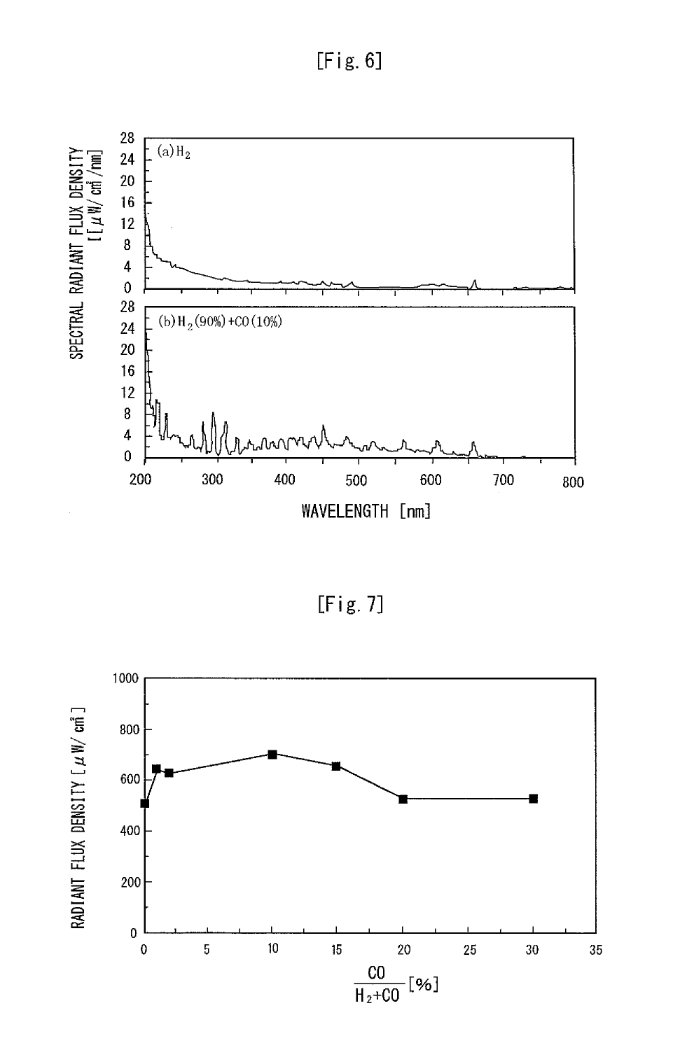

FIG. 6 depicts discharge emission spectrums in the multi-poled magnetic field with two types of molecular gas.

FIGS. 6(a) and 6(b) depict spectrums when hydrogen and hydrogen-diluted (90%) carbon oxide (10%) gas are used, respectively, as molecular gas. Here, the gas pressure is 0.3 Torr, and the vertical axis represents spectral radiant flux densities [μW/cm²/nm] calibrated with a standard light source.

In both of the hydrogen gas in FIG. 6(a) and the hydrogen-diluted carbon oxide gas in FIG. 6(b), ultraviolet radiation from a short-wavelength region of about 300 nm or shorter was observed. Here, since it is generally known that strong vacuum ultraviolet rays are emitted from carbon oxide gas in a region of 200 nm or shorter, ultraviolet rays in this region are considered to be emitted also in this experiment. In the experiment, the reason why a spectrum of 200 nm or shorter cannot be observed is that the light extraction window depicted in FIG. 1 used in the experiment is a quartz window through which vacuum ultraviolet rays cannot be transmitted and that a spectroscope used cannot measure vacuum ultraviolet rays.

As depicted in FIG. 7, it was found that ultraviolet radiation from this region is maximum when carbon oxide is diluted with hydrogen to make the concentration of carbon oxide approximately 10%.

Here in FIG. 7, the vertical axis represents radiant flux densities [μW/cm²] and the horizontal axis represents carbon oxide concentrations CO/H₂+CO [%]. Here, the multi-poled magnetic fields in FIG. 6 and FIG. 7 are double-comb-type multi-poled magnetic fields.

From FIG. 7, it can be found that the radiant flux density is large when the concentration of carbon oxide of the hydrogen-diluted carbon oxide gas is within a range of from 1 to 15% and it is small outside of this range. The reason for this is considered as follows. If the concentration of carbon oxide is smaller than 1%, the number of carbon oxide molecules, which are main constituents of ultraviolet and vacuum ultraviolet emission, is insufficient. If the concentration exceeds 15%, it becomes difficult to effectively excite carbon oxide from hydrogen molecules, which is a diluent gas.

In the case of carbon oxide gas, a brown carbon film occurred at the light extraction window 32. By using hydrogen-diluted carbon oxide gas as a molecular gas, formation of a carbon film occurring due to dissociation of carbon oxide was suppressed.

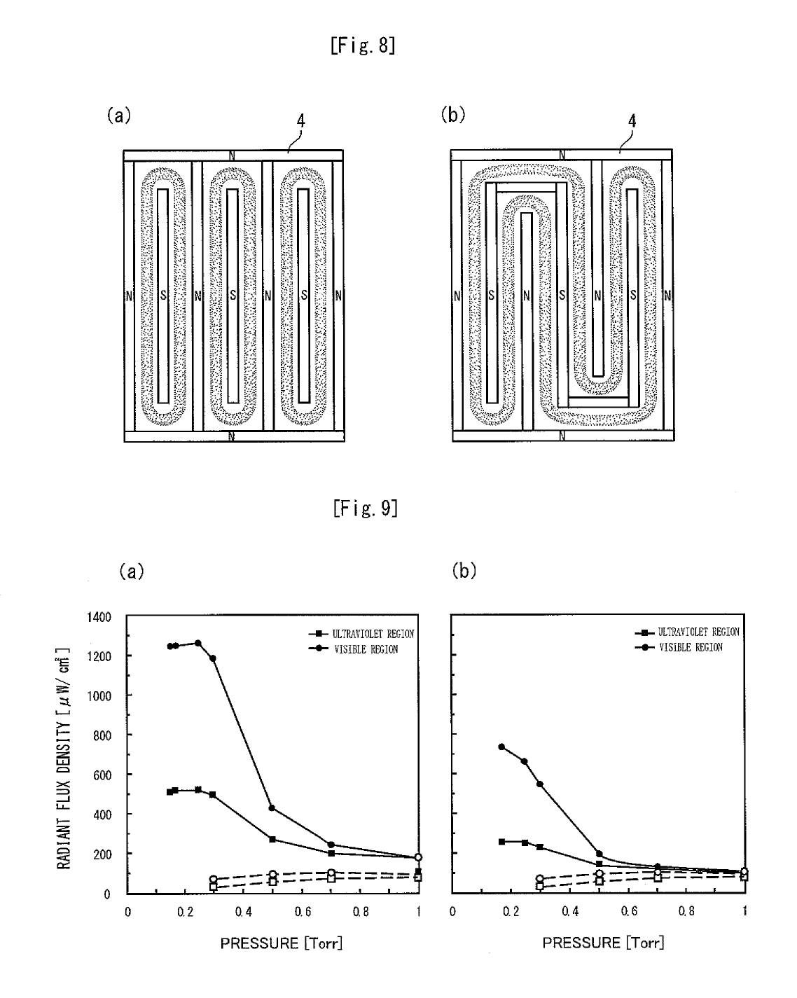

Furthermore, by changing the configuration of the multi-poled magnetic field, a comparative experiment was performed between a multi-race-type magnetic field as depicted in FIG. 8(a) in which S poles and N poles of the rod magnets 4 are arranged in a race track shape and a double-comb-type magnetic field as depicted in FIG. 8(b) in a shape in which teeth of two combs are engaged with each other. Here, only data in the case of using nitrogen gas is shown.

As depicted in FIG. 9, as the pressure decreased, the luminous intensity increased in both of the ultraviolet and visible regions, and the multi-race-type magnetic field depicted in FIG. 9(a) had luminous intensity several times as strong as that of the double-comb-type magnetic field depicted in FIG. 9(b). Here, data with black square and white square marks in FIG. 9 represent radiant flux densities in a ultraviolet region, and is found by integrating spectral radiant flux densities within a range of wavelengths of from 200 nm to 380 nm. Also, data with black circle and white circle marks in that figure represent those in a visible region, and is obtained by integrating spectral radiant flux densities within a range of wavelengths of from 380 nm to 780 nm. Furthermore, solid lines represent the case in the multi-poled magnetic field, and broken lines represent the case without a magnetic field.

### DESCRIPTION OF REFERENCE NUMERALS

1 divisional electrode
2 barrier layer
3 flat container
31 substrate
32 light extraction window
4 magnet
5 magnetic shield plate
6 twelve-phase alternating-current power supply
a space
b fluorescent material (not shown)
P plasma

1. An ultraviolet generating device generating a plurality of ultraviolet rays by exciting a discharge gas with a weakly-ionized low-temperature plasma, wherein
said discharge gas is a mixed gas of a nitric oxide and a diluent gas.

2. The ultraviolet generating device according to claim 1, wherein
said diluent gas is a chemically stable gas.

3. The ultraviolet generating device according to claim 1, wherein
said diluent gas is a gas with a metastable level higher than an excitation level of nitric oxide.

4. The ultraviolet generating device according to claim 1, wherein
said diluent gas is a nitrogen gas.

5. The ultraviolet generating device according to claim 1, wherein
said mixed gas has a concentration of nitric oxide of 5 to 50%.

6. The ultraviolet generating device according to claim 1, wherein a plasma generating device that generates said weakly-ionized low-temperature plasma includes:
n sheet-shaped divisional electrodes laid on a flat substrate with a plurality of slight spaces therebetween;
a plurality of magnets that form a multi-poled magnetic field so as to cover a surface of the divisional electrodes with magnetic lines of force;
a phase-controlled n-phase alternating-current power supply that supplies the divisional electrodes with discharge electrical energies having phases shifted by a 1/n cycle and having a same amplitude.

7. A lighting device wherein
said ultraviolet rays generated in the device according to claim 1 are applied to a fluorescent material for conversion into visible light.
